(19) United States
(12) Patent Application Publication
(10) Pub. No.: US 2026/0108872 A1
(43) Pub. Date: Apr. 23, 2026

(54) DEVICES FOR DROPLET DEPOSITION AND METHODS OF MAKING THEREOF

(71) Applicants: THE REGENTS OF THE UNIVERSITY OF CALIFORNIA, Oakland, CA (US); LAWRENCE LIVERMORE NATIONAL SECURITY, LLC, Livermore, CA (US)

(72) Inventors: Kshitiz GUPTA, Berkeley, CA (US); Trent R. NORTHEN, Walnut Creek, CA (US)

(21) Appl. No.: 19/424,264

(22) Filed: Dec. 18, 2025

Related U.S. Application Data
(63) Continuation of application No. PCT/US2024/052065, filed on Oct. 18, 2024.
(60) Provisional application No. 63/591,847, filed on Oct. 20, 2023.
(60) Provisional application No. 63/744,677, filed on Jan. 13, 2025.
(60) Provisional application No. 63/752,249, filed on Jan. 31, 2025.

(51) Int. Cl. B01L 3/02

(52) U.S. Cl. CPC B01L 3/021; B01L 2200/12

(57) ABSTRACT

This disclosure provides systems, methods, and apparatus related to depositing droplets. In one aspect, a device includes a base and an array of deposition tips attached to the base. The array of deposition tips is at least a 2×1 array of deposition tips. Each deposition tip of the array of deposition tips comprises a rod having a cylindrical cross section. The rod has a first diameter at a first end and a second diameter at a second end. The first diameter is greater than the second diameter. The first end of the rod is attached to the base. The rod includes a bend comprising a cantilever spring.

### RELATED APPLICATIONS

This application claims priority to Patent Cooperation Treaty Application No. PCT/US2024/052065, filed 18 Oct. 2024, which claims priority to U.S. Provisional Ser. No. 63/591,847 , filed 20 Oct. 2023, both of which are hereby incorporated by reference. This application also claims priority to U.S. Provisional Ser. No. 63/744,677, filed 13 Jan. 2025, and to U.S. Provisional Ser. No. 63/752,249, filed 31 Jan. 2025, both of which are hereby incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to devices for depositing droplets and methods of making thereof.

### BACKGROUND

Mass spectrometry techniques such as nanostructure-initiator mass spectrometry (NIMS) and matrix-assisted laser desorption/ionization mass spectrometry (MALDI) use a laser to ionize target molecules. Molecules such as sugars, alcohols, lignin-derived substrates, and many others are deposited on an electrically conductive surface prior to desorption and ionization. The throughput of such characterization techniques is dependent on the number density of the sample molecule arrays deposited on the laser target plate.

Commercial droplet deposition tools are able to generate 1536 well format arrays. Such tools use complex pneumatic and acoustic techniques to eject droplets on to the target plate surface, making denser patterns unreliable and not repeatable.

### SUMMARY

Described herein are devices including an array of deposition tips that can be used as a soft stamp for depositing nanoliter scale droplets (i.e., nanodroplets) onto a substrate (e.g., a laser target plate). In some embodiments, deposition tips use a surface tension driven contact-based droplet transfer mechanism. As the droplet transfer is contact based, the location of the samples on a substrate can be controlled with high precision. This helps to prevents cross-contamination, which is frequently observed in commercial droplet deposition tools due to droplet coalescence.

Described herein are deposition tips and arrays of deposition tips, with the deposition tips including liquid catches.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a cross-sectional schematic illustration of a device including a deposition tip.

FIG. 2 shows an example of a schematic illustration of a device including an array of deposition tips.

FIG. 3 shows an example of a schematic illustration of a device including an array of deposition tips.

FIG. 4 shows an example of a flow diagram illustrating a manufacturing process for a device including an array of deposition tips.

FIG. 5 shows an example of a cross-sectional schematic illustration of a device including an array of deposition tips.

FIG. 6 shows an example of a schematic illustration of a device including an array of deposition tips.

FIG. 7A shows an example of a schematic illustration of a device. FIG. 7B shows an example of a cross-sectional schematic illustration of a device.

FIGS. 8A and 8B show examples of schematic illustrations of a liquid catch of a rod of a deposition tip.

FIG. 9A shows an example of a schematic illustration of a device including a deposition tip. FIG. 9B shows an example of a cross-sectional schematic illustration of a device including a deposition tip.

FIG. 10 shows an example of a schematic illustration of a device including an array of deposition tips that include liquid catches.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Described herein are devices including an array of deposition tips that can be used to perform soft contact-based nanodroplet deposition on surfaces. Standard, commercially available, pipette tips are stiff and are designed to transfer liquids using, for example, pneumatic actuation. Standard pipette tips are designed to transfer a wide range of quantities of a liquid, about 100 nanoliters (nl) to 1 milliliter (ml). The deposition tips described herein are designed to transfer small quantities (on the order of about 100 nl or less) of a liquid. The liquid may be any number of liquids, including target molecules dissolved in a solvent, a chemical, or a biochemical. The deposition tips, unlike standard pipette tips, are not hollow in some embodiments. The deposition tips are also designed to contact a substrate, again unlike standard pipette tips.

When a fluid handling robot loads a set of standard pipette tips (e.g., a 96 well format), the ends of all of the standard pipette tips may not lie in the same plane. Further, due to some variability in the flatness of the substrate, the pipette tip size, and the manner in which the pipette tips are attach to a fluid dispensing head, there may be a gap between the some ends of the tips and the substrate. Because of this, all the pipette tips may not transfer their contents on to the substrate.

The devices including deposition tips described herein include a spring mechanism as part of the deposition tip that helps to ensure all the deposition tips in an array of deposition tips contact a substrate by compressing deposition tips that are at a different height than other deposition tips. The deposition tips are operable to transfer samples to a substrate by contacting the substrate. The deposition tips are also designed to interface with existing liquid handling/dispensing equipment.

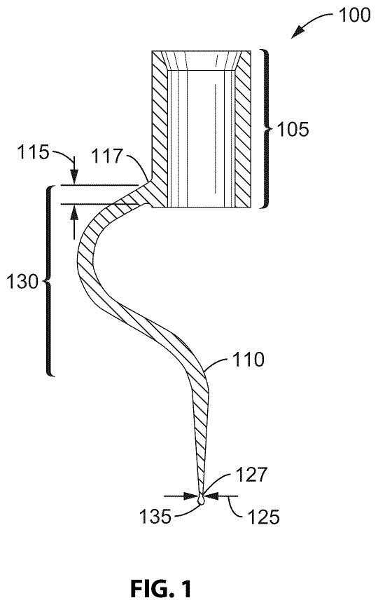

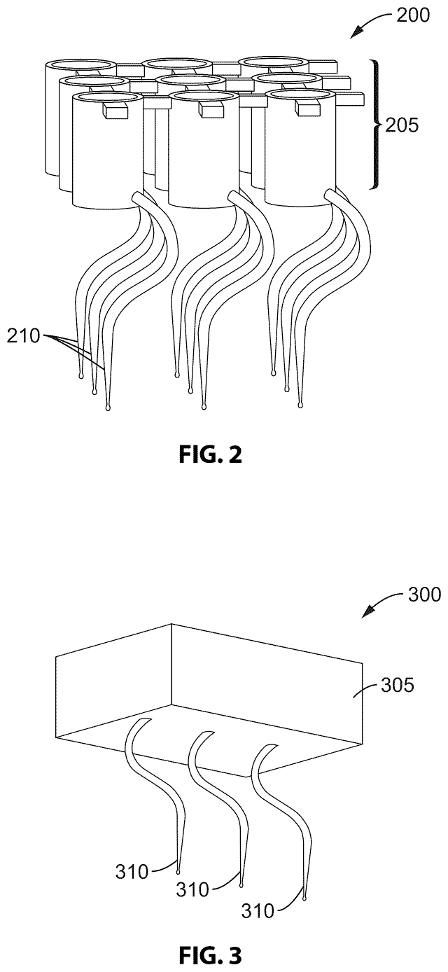

FIG. 1 shows an example of a cross-sectional schematic illustration of a device including a deposition tip. FIG. 2 shows an example of a schematic illustration of a device including an array of deposition tips. As shown in FIG. 1, a device 100 includes a base 105 and a deposition tip 110 attached to the base 105. As shown in FIG. 2, a device 200 includes a base 205 and an array of deposition tips 210 attached thereto. The array of deposition tips is at least a 2×1 array of deposition tips.

The deposition tips are described herein as being attached to the base. In some embodiments, the deposition tips being attached to the base also includes instances in which the deposition tips are part of the base. For example, the deposition tips being part of the base may occur in instances in which the device is injection molded. In some embodiments, the base and the deposition tips comprise the same material. In some embodiments, the base and the deposition tips are molded from the same material (e.g., a polymer).

Turning back to FIG. 1, a deposition tip 110 comprises a rod having a cylindrical cross section. The rod has a first diameter 115 at a first end 117 and a second diameter 125 at a second end 127. In some embodiments, the first diameter 115 is greater than the second diameter 125. In some embodiments, the first diameter is about 1 millimeter (mm). In some embodiments, the second diameter is about 200 microns to 700 microns. The first end 117 of the rod is attached to the base 105. In some embodiments, the first diameter 115 is the same as or about the same as the second diameter 125.

The rod includes a bend 130 comprising a cantilever spring or forming the rod into a cantilever spring. A cantilever spring is a spring having a fixed end and a floating end that comprises a material with an elastic modulus such that the floating end of the spring can bend an amount and then return to its original position.

In some embodiments, the bend 130 forming the cantilever spring in the rod is proximate the first end 117 of the deposition tip 110. For example, in some embodiments, the bend 130 forming the cantilever spring in the rod starts at the first end 117 of the deposition tip. In some embodiments, the bend 130 has a radius or curvature of about 3 mm to 6 mm.

In some embodiments, the rod is straight (i.e., does not include a bend) proximate the second end 127 of the deposition tip 110. In some embodiments, the straight portion of the rod is substantially perpendicular to a plane defined by the base 205 shown in FIG. 2. When the straight portion of the rod is substantially perpendicular to a plane defined by the base 205, when an array of deposition tips is brought into contact with a substrate (e.g., with a plane defined by the base 205 substantially parallel to the surface of the substrate), the deposition tips 210 will contact the substrate at about the same point (i.e., when the base 205 is a specified distance from the substrate).

All of the deposition tips, however, will likely not contact the substrate at the same point. For example, define a plane in which a majority of the second ends of the deposition tips reside. The deposition tips not in that plane may be slightly above or above the plane or slightly below or below the plane. These variations in deposition tip height may be due to the manufacturing tolerances of the array of deposition tips, for example. In some embodiments, the substrate is substantially flat. However, there may be variations in the flatness of a substrate. When the deposition tips are contacted to a substrate, the deposition tips that are slightly below the plane will contact the substrate first. The springs of these deposition tips will compress and then the majority of the deposition tips will contact the substrate. Then, the springs of the majority of the deposition tips will compress as well and the tips that were above the plane will contact the substrate. The cantilever spring of each deposition tip allows for all or substantially all of the deposition tips to contact the substrate.

In some embodiments, the second end of the deposition tip comprises a rounded end. In some embodiments, a diameter of the rounded end is about the second diameter or a larger diameter. The size of the rounded end specifies, in part, the minimum size of a droplet that is deposited. The size of the rounded end can be specified for the specific application for which a deposited droplet will be used.

In some embodiments, a length of the rod is about 30 mm to 40 mm. In some embodiments, a length of the rod measured from the base is about 15 mm to 25 mm, or about 20 mm. The length of the rod may be specified to vary the stiffness of the cantilever spring; a greater length of the bend comprising the cantilever spring makes for a less stiff spring.

In some embodiments, the rod is a tapering rod. In some embodiments, the rod is a cylindrical rod. In some embodiments, the rod is a tapering cylindrical rod.

In some embodiments, the base is configured to interface with an array of pipettes. In some embodiments, each deposition tip in the array of deposition tips corresponds to a pipette in the array of pipettes. Such an interface would allow the device to be used with existing liquid handling/dispensing equipment. For example, the base 205 shown in FIG. 2 can be used to mount the device on liquid handling/dispensing equipment that uses standard pipette tips.

In some embodiments, the device comprises a polymer. In some embodiments, the polymer is a polymer from a group polypropylene, a cyclo-olefin (COC), polycarbonate (PC), polyether ether ketone (PEEK), and polytetrafluoroethylene (PTFE). Other polymers that have moderate chemical resistance and that are able to be sterilized and/or cleaned in an autoclave can also be used.

In some embodiments, the second end of each deposition tip of the array of deposition tips is about 9 mm from the second end of any other deposition tip in the array. In some embodiments, the array of deposition tips is an 8×1 array of deposition tips or an 8×12 array of deposition tips. In some embodiments, an 8×12 array of deposition tips is arranged such that the deposition tips are arranged in a square pattern. Such an 8×12 array of deposition tips would allow the deposition tips to be immersed in liquids contained in a 96-well plate. Different wells in the well plate could contain the same liquid or different liquids. 96-well plates have a 9 mm well-to-well spacing. An 8×1 array of deposition tips could be used with a row of wells of a 96-well plate. Other standard well plates could be also be used with different arrays of deposition tips. For example, a 24-well plate (4×6 array of deposition tips), a 48-well plate (6×8 array of deposition tips), 384-well plate (16×24 array of deposition tips), a 1536-well plate (32×48 array of deposition tips), and a 6144-well plate (64×96 array of deposition tips) can be used.

To obtain a high density of liquid droplets on a substrate, the deposition tips of an array of deposition tips are contacted with the substrate after dipping the tips in specified liquids. The specified liquids may be contained in a well plate, for example. Then, the array of deposition tips may be shifted by a small distance (e.g., about 1 mm), depending on the size of the array. Then, the deposition tips may be contacted again with the substrate. This process could be repeated until the array of deposition tips is shifted up to a point that the liquid droplets will be deposited on top of one another. The deposition tips may be dipped in the specified liquids (e.g., contained in a well plate), as needed, during the droplet deposition process. Such an offsetting technique can be used to create 6144 (and even denser) liquid droplet patterns using an array of deposition tips (e.g., an array of 96 deposition tips).

In some embodiments, the second end of the rod comprises a polymer ball. Such a polymer ball 135 is shown in FIG. 1. In some embodiments, a polymer of the polymer ball is a hydrophobic polymer. For example, the liquid to be deposited may be hydrophobic or hydrophilic. If the liquid is hydrophobic, the polymer ball may be hydrophobic. In such cases, when a liquid is adsorbed to a deposition tip, the liquid will be transferred to the substrate when contacted with the deposition tip.

In some embodiments, the polymer ball comprises a polymer or is a polymer from a group polydimethylsiloxane (PDMS), a silicone, and a hydrogel. PDMS may be used as hydrophobic compounds are adsorbed on it after the deposition tip is dipped in a well containing the compound. The compound is then transferred to the substrate when the deposition tip is contacted to the substrate. Hydrogels can be used as they absorb liquids (e.g., similar to a sponge). For example, a hydrogel that can be used is polyethylene glycol diacrylate (PEGDA). Other inert and stable elastomeric polymers may also be used. Different polymers for the polymer ball may be specified based on the liquid deposition requirements. In some embodiments, the polymer ball is about 500 microns to 700 microns in diameter, or about 500 microns in diameter.

In some embodiments, instead of the rod having a cylindrical cross section (i.e., the rod being a cylindrical rod), the rod may have a different cross section, such as a square cross section or a triangular cross section.

FIG. 3 shows an example of a schematic illustration of a device including an array of deposition tips. As shown in FIG. 3, a device 300 includes a base 305 with an array of deposition tips 310 attached thereto.

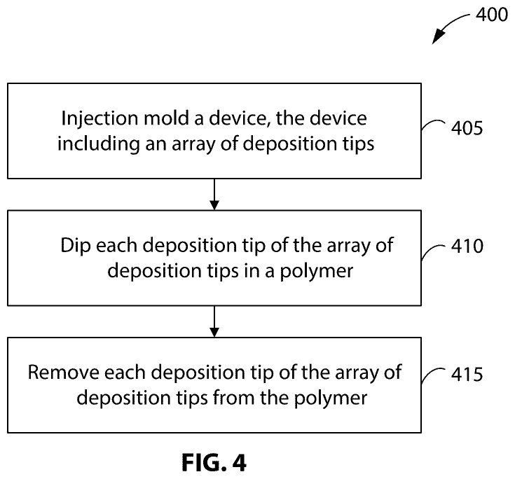

FIG. 4 shows an example of a flow diagram illustrating a manufacturing process for a device including an array of deposition tips. The manufacturing process described in FIG. 4 may be used to manufacture the devices described in FIGS. 1-3.

Starting at block 405 of the process 400 shown in FIG. 4, a device is injection molded. In some embodiments, the device is injection molded with a polymer. I.e., in some embodiments, the device comprises a polymer. The device comprises a base and an array of deposition tips attached to base. The array of deposition tips is at least a 2×1 array of deposition tips. Each deposition tip of the array of deposition tips comprises a rod having a cylindrical cross section. The rod has a first diameter at a first end and a second diameter at a second end, with the first diameter being greater than the second diameter. The first end of the rod is attached to the base. The rod includes a bend comprising a cantilever spring.

In some embodiments, instead of injection molding the device, the device is fabricated using a 3D printer.

In some embodiments, the process 400 further includes dipping each deposition tip of the array of deposition tips in a second polymer at block 410. In some embodiments, the second polymer is a hydrophobic polymer. At block 410, each deposition tip of the array of deposition tips is removed from the second polymer. After block 410, the mass of the second polymer forms the polymer ball; for example, when holding a plane defining the base parallel to the ground after removing the deposition tips from the second polymer. In some embodiments, the second polymer is a polymer from a group polydimethylsiloxane (PDMS), a silicone, and a hydrogel. In some embodiments, the process 400 further includes curing the second polymer. For example, when the second polymer is PDMS, the curing operation may include curing the PDMS in an oven at about 80° C.

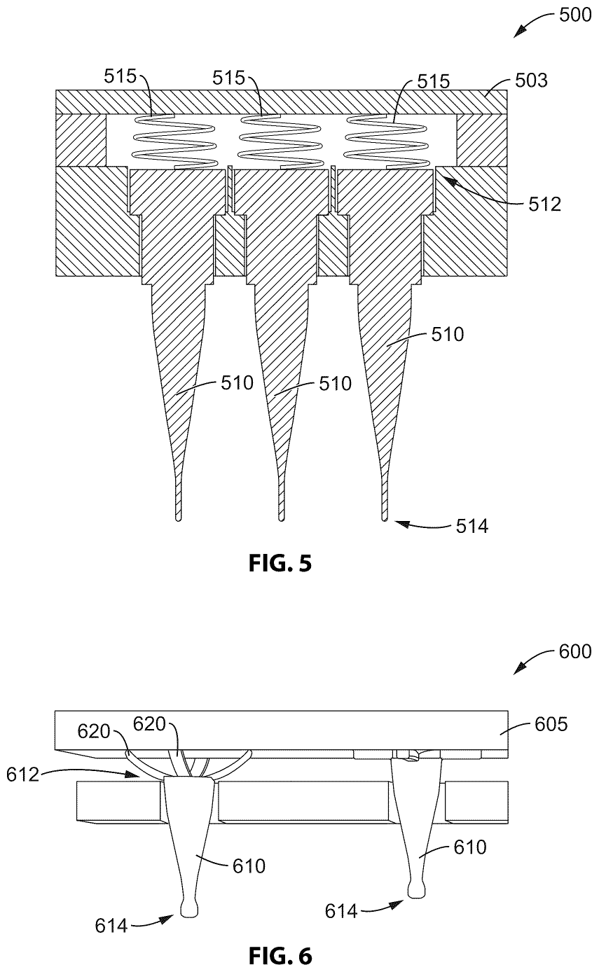

FIG. 5 shows an example of a cross-sectional schematic illustration of a device including an array of deposition tips. As shown in FIG. 5, a device 500 includes a base 505 and an array of deposition tips 510. The base 505 has a first side and a second side. The array of deposition tips 510 is at least a 2×1 array of deposition tips (e.g., three deposition tips 510 form the array shown in FIG. 5). Each deposition tip 510 of the array of deposition tips includes a rod having a first end 512 and a second end 514. A spring 515 is proximate the first end 512 of each deposition tip 510 of the array of deposition tips. The spring 515 is operable to be compressed to enable motion of second end 514 of each of the deposition tips 510 substantially parallel to a length of each of the deposition tips.

The spring associated with each of the deposition tips allows all of the deposition tips to contact a substrate, similar to the embodiment described with respect to FIG. 1-3. In some embodiments, the spring is operable to be compressed substantially parallel to a length of each of the deposition tips. In some embodiments, each of the springs proximate the first end of each deposition tips of the array of deposition tips is substantially the same. In some embodiments, each of the springs proximate the first end of each deposition tip of the array of deposition tips comprises a metal spring or a polymer spring.

In some embodiments, each of the springs proximate the first end of each deposition tip of the array of deposition tips comprises a compression spring. In some embodiments, a deposition tip and the compression spring comprise a single body. For example, a deposition tip and a compression spring can be injection molded or 3D printed as a single, unitary component.

In some embodiments, each of the springs proximate the first end of each deposition tip of the array of deposition tips is a spring from a group a helical spring, a coil spring, and a conical spring. In some embodiments, each of the springs proximate the first end of each deposition tip of the array of deposition tips is in contact with the first end of each deposition tip (i.e., a spring is in contact with first end of the deposition tip even when the array of deposition tips is not being used to deposit samples).

In some embodiments, each of the springs proximate the first end of each deposition tip of the array of deposition tips comprises at least two leaf springs that are about 15° to 60°, or about 30°, to a plane perpendicular to the length of the rod and that extend from a first end of the rod. In some embodiments, the at least two leaf springs position the first end of the rod about 1 mm to 3 mm from the planar base. In some embodiments, the leaf springs are operable to be flattened against the second side of the base such that the first end of the rod is in contact with the second side of the base (see FIG. 6). Such compression would happen when a deposition tip moves substantially parallel to the rod comprising the deposition tip

In some embodiments, each of the springs proximate the first end of each deposition tip of the array of deposition tips comprises two leaf springs. In some embodiments, each of the springs proximate the first end of each deposition tip of the array of deposition tips comprises three leaf springs. In some embodiments, each of the springs proximate the first end of each deposition tip of the array of deposition tips comprises four leaf springs.

In some embodiments, the deposition tip and the at least two leaf springs comprise a single body. For example, a deposition tip and the at least two leaf springs can be injection molded or 3D printed as a single, unitary component. Note that the leaf springs described above are shown in FIG. 6, which is described below.

In some embodiments, a length of the rod of each of the deposition tips 510 is about 10 mm to about 30 mm. In some embodiments, the rod is a tapering rod. In some embodiments, the rod is a cylindrical rod. In some embodiments, the rod has a first diameter at a first end and a second diameter at a second end, with the first diameter being greater than the second diameter. In some embodiments, the second end of the rod comprises a rounded end. In some embodiments, a diameter of the rounded end of the rod is about the second diameter or a larger diameter. In some embodiments, the rounded end has a diameter of about 500 microns to 700 microns.

In some embodiments, the deposition tip 510 comprises a polymer from a group polypropylene, a cyclo-olefin (COC), polycarbonate (PC), polyether ether ketone (PEEK), and polytetrafluoroethylene (PTFE).

In some embodiments, the second end of the deposition tip 510 comprises a polymer ball. In some embodiments, a polymer of the polymer ball is a hydrophobic polymer. In some embodiments, the polymer ball is a polymer from a group polydimethylsiloxane (PDMS), a silicone, and a hydrogel. In some embodiments, the polymer of the polymer ball is a hydrophilic polymer. In some embodiments, the polymer ball comprises polyethylene glycol diacrylate (PEGDA). In some embodiments, the polymer ball is about 500 microns to 700 microns in diameter.

In some embodiments, the first side of the base 505 is operable to interface with an array of pipettes, with each deposition tip in the array of deposition tips corresponds to a pipette in the array of pipettes.

In some embodiments, the second end of each deposition tip of the array of deposition tips is about 9 mm from the second end of any other deposition tips in the array. In some embodiments, the array of deposition tips is an 8×1 array of tips or an 8×12 array of deposition tips. In some embodiments, the 8×12 array of deposition tips is arranged such that the deposition tips are arranged in a square pattern.

FIG. 6 shows an example of a schematic illustration of a device including an array of deposition tips. As shown in FIG. 6, a device 600 includes a base 605 and an array of deposition tips 610. The base 605 has a first side and a second side. The second side of the base 605 comprise a planar surface. The array of deposition tips 610 is at least 2×1 array of deposition tips. Each deposition tip 610 of the array of deposition tips includes a rod having a first end 612 a second end 614. A deposition tip 610 includes at least two sections 620 that are about 15° to 60°, or about 30,° to a plane perpendicular to the length of the rod and that extend from a first end of the rod. In some embodiments, the sections 620 extend from a first end of the rod about 0.5 mm to 15 mm (i.e., the sections 620 have a length of about 0.5 mm to 15 mm). The at least two sections 620 position the first end 612 of the rod about 1 mm to 3 mm from the second side of the base 605 (e.g., see the deposition tip on the left hand side of FIG. 6). In some embodiments, the at least two sections 620 are operable to be flattened against the base such that the first end of the rod is in contact with the base (e.g., see the deposition tip on the right hand side of FIG. 6). In some embodiments, areas of the at least two sections 620 are operable to be pushed closer to the base with the first end of the rod also being pushed closer to the base.

As shown in the embodiment of the device 600 shown in FIG. 6, the sections 620 are curved. In some embodiments, a section 620 is not curved. In some embodiments 620, a section 620 can lie in a plane.

In some embodiments, the at least two sections 620 are leaf springs. In some embodiments, the at least two sections 620 comprise two leaf springs. In some embodiments, the at least two sections 620 comprise three leaf springs. In some embodiments, the at least two sections 620 comprise four leaf springs.

In some embodiments, the deposition tip 610 and the at least two sections 620 comprise a single body. For example, a deposition tip 610 and the at least two sections 620 can be injection molded or 3D printed as a single, unitary component.

In some embodiments, a length of the rod of a deposition tip 610 is about 10 mm to about 30 mm. In some embodiments, the rod is a tapering rod. In some embodiments, the rod is a cylindrical rod. In some embodiments, the rod has a first diameter at a first end and a second diameter at a second end, with the first diameter being greater than the second diameter. In some embodiments, the second end of a rod of a deposition tip comprises a rounded end. In some embodiments, a diameter of the rounded end of the rod is about the second diameter or a larger diameter. In some embodiments, the rounded end has a diameter of about 500 microns to 700 microns.

In some embodiments, the deposition tip 610 comprises a polymer from a group polypropylene, a cyclo-olefin (COC), polycarbonate (PC), polyether ether ketone (PEEK), and polytetrafluoroethylene (PTFE).

In some embodiments, the second end of the rod comprises a polymer ball. In some embodiments, a polymer of the polymer ball is a hydrophobic polymer. In some embodiments, the polymer ball is a polymer from a group polydimethylsiloxane (PDMS), a silicone, and a hydrogel. In some embodiments, the polymer of the polymer ball is a hydrophilic polymer. In some embodiments, polymer ball comprises polyethylene glycol diacrylate (PEGDA). In some embodiments, the polymer ball is about 500 microns to 700 microns in diameter.

In some embodiments, the first side of the base is configured to interface with an array of pipettes, and wherein each deposition tip in the array of deposition tips corresponds to a pipette in the array of pipettes.

In some embodiments, the second end of each deposition tip of the array of deposition tips is about 9 mm from the second end of any other deposition tips in the array. In some embodiments, the array of deposition tips is an 8×1 array of tips or an 8×12 array of deposition tips. In some embodiments, the 8×12 array of deposition tips is arranged such that the deposition tips are arranged in a square pattern.

In some embodiments, the rod of a deposition tip includes at least two liquid catches. Such a deposition tip could be use to deposit a first liquid using a first liquid catch. Then, the rod could be broken below a second catch and the same deposition tip could be used to deposit a second liquid (in such instances, the second liquid would usually be a different liquid than the first liquid). Such a deposition tip would be less wasteful of material, with the same deposition tip being used to deposit different liquids.

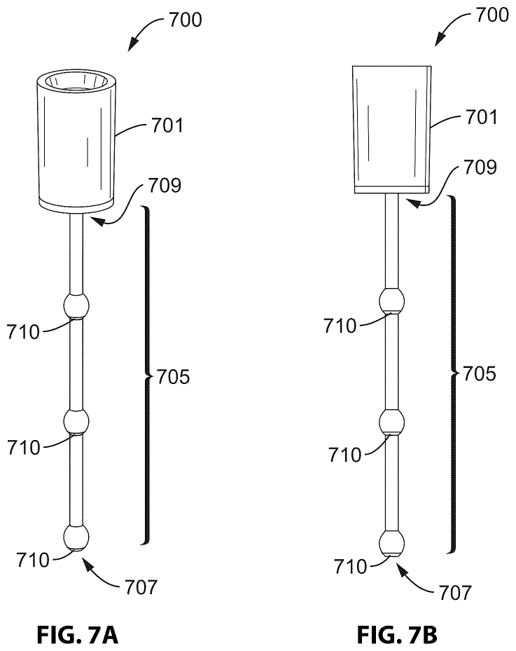

FIG. 7A shows an example of a schematic illustration of a device. FIG. 7B shows an example of a cross-sectional schematic illustration of a device.

As shown in FIGS. 7A and 7B, a deposition tip 700 includes a rod 705 and at least two liquid catches 710 positioned on the rod 705 (e.g., the rod 705 includes three liquid catches). A first liquid catch 710 is positioned at a first end 707 of the rod 705 and a second liquid catch 710 is positioned a distance from the first liquid catch 710. A liquid catch 710 comprises a protrusion from the rod along a perimeter of a cross-section of the rod.

In some embodiments, the deposition tip includes two to five liquid catches. In some embodiments, the deposition tip includes two liquid catches. In some embodiments, the deposition tip includes three liquid catches. In some embodiments, the deposition tip includes four liquid catches. In some embodiments, the deposition tip includes five liquid catches.

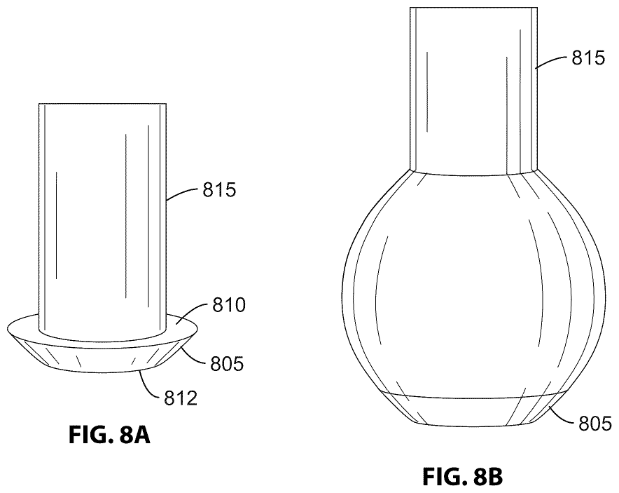

FIG. 8A shows an example of a schematic illustration of a liquid catch. FIG. 8B shoes an example of a schematic illustration of a liquid catch with a liquid thereon. As shown in FIG. 8A, a protrusions 810 and 812 comprising a liquid catch 805 are substantially perpendicular to a length of the rod. In some embodiments, protrusions comprising each of the at least two liquid catches are substantially perpendicular to a length of the rod. That is, surfaces (i.e., the protrusions) of each the at least two liquid catches are substantially perpendicular to a length of the rod.

In some embodiments, the protrusion 810 comprising the liquid catch 805 is about 0.2 mm to 1 mm. In some embodiments, the liquid catch 805 extends about 0.2 mm to 1 mm along a length of the rod 815. In some embodiments, the protrusion 812 proximate the first end of the rod protrudes less than the protrusion 810 proximate a second end of the rod.

Returning to FIGS. 7A and 7B, when in use, the first end 707 of the deposition tip 700 is dipped in a liquid that is to be deposited on a substrate, with only the first liquid catch 710 (i.e., the liquid catch proximate the first end of the rod) being immersed in the liquid. The first liquid catch holds a small amount of the liquid via surface tension (see FIG. 8B). When the first end 707 of the deposition tip 700 is contacted with a substrate, the liquid held by the first liquid catch would be transferred to the substrate. The amount of liquid retained on the first liquid catch depends on the properties of the liquid and the size of the catch (i.e., the sizes of the protrusions).

After using the first liquid catch 710 of the deposition tip 700 to deposit a sample, the rod 705 extending from the second liquid catch 710 (i.e., the portion of the rod 705 between the first liquid catch and the second liquid catch) is removed. Then the second liquid catch 710 is used, and the rod 705 extending from the third liquid catch 710 (i.e., the portion of the rod 705 between the second liquid catch and the third liquid catch) is removed. Then the third liquid catch 710 is used. This process is repeated until all of the liquid catches are used.

Alternatively, if the same liquid is being deposited on the substrate, the first liquid catch 710 can be reused (i.e., the portion of the rod 705 between the first liquid catch and the second liquid catch is not removed).

In some embodiments, the rod 705 of the deposition tip 700 has a cross-sectional dimension of about 0.5 mm to 3 mm. In some embodiments, the rod 705 has a diameter of about 0.5 mm to 3 mm. In some embodiments, the rod 705 has a cross-section of a shape from a group a circle, a triangle, and a square. That is, the rod 705 has a circular cross-section, a triangular cross-section, or a square-shaped cross-section. In some embodiments, a length of the rod 705 is about 20 mm to 40 mm. In some embodiments, a distance between the liquid catches 710 along the length of the rod 705 is about 10 mm to 15 mm.

In some embodiments, the rod 705 of the deposition tip 700 is scored below each liquid catch 710 for each liquid catch except for the first liquid catch (i.e., the liquid catch positioned at the first end 707 of the rod 705). The scoring may aid cutting the rod or breaking the rod after the first liquid catch (and subsequent liquid catches) is used. In some embodiments, the rod has a smaller cross-sectional dimension below each liquid catch for each liquid catch except for the first liquid catch. The smaller cross-sectional dimension may aid in cutting the rod or breaking the rod after the first liquid catch (and subsequent liquid catches) is used.

In some embodiments, a second end 709 of the rod 705 is attached to an adaptor such that the rod can be fit on the end of a pipette. In some embodiments, the adaptor comprises a hollow cylinder. In some embodiments, the adaptor comprises a tapered hollow cylinder.

In some embodiments, the deposition tip 700 comprises a polymer from a group polypropylene, polyether ether ketone (PEEK), polycarbonate, low density polyethylene (LDPE), high density polyethylene (HDPE), and polyethylene terephthalate glycol (PET-G).

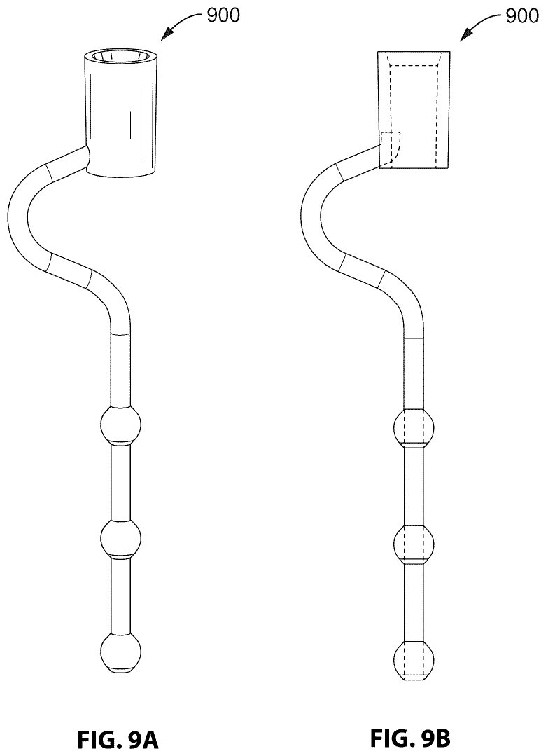

The liquid catches described with respect to FIGS. 7A, 7B, 8A, and 8B can be included with any of the devices or deposition tips described herein. For example, elements of the deposition tip 700 shown in FIGS. 7A and 7B can be included in the devices, including arrays of deposition tips, described above with respect to FIG. 1-3, 5, and 6. FIG. 9A shows an example of a schematic illustration of a device including a deposition tip. FIG. 9B shows an example of a cross-sectional schematic illustration of a device including a deposition tip. As shown in FIGS. 9A and 9B, the deposition tip 900 includes a cantilever spring similar to that shown in FIG. 1-3 and the rod shown in FIGS. 7A and 7B. Multiple deposition tips 900 can be arranged as an array of deposition tips.

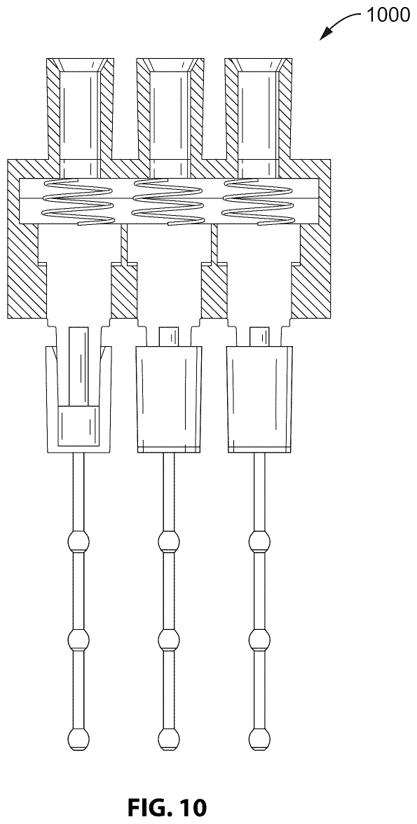

FIG. 10 shows an example of a schematic illustration of a device including an array of deposition tips. As shown in FIG. 10, the array of deposition tips 1000 includes springs similar to the device shown in FIG. 5 and the rod shown in FIGS. 7A and 7B.

### CONCLUSION

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A device comprising:
a base; and
an array of deposition tips attached to the base, the array of deposition tips being at least a 2×1 array of deposition tips, each deposition tip of the array of deposition tips comprising a rod having a cylindrical cross-section, the rod having a first diameter at a first end and a second diameter at a second end, the first diameter being greater than the second diameter, the first end of the rod being attached to the base, and the rod including a bend comprising a cantilever spring.

2. The device of claim 1, wherein the first diameter is about 1 millimeter, and wherein the second diameter is about 200 microns to 700 microns.

3. The device of claim 1, wherein the second end comprises a rounded end.

4. The device of claim 1, wherein the second end comprises a rounded end, and wherein a diameter of the rounded end is about the second diameter or a larger diameter.

5. The device of claim 1, wherein a length of the rod is about 30 millimeters to 40 millimeters.

6. The device of claim 1, wherein a length of the rod measured from the base is about 15 millimeters to 25 millimeters.

7. The device of claim 1, wherein the rod is a tapering rod.

8. The device of claim 1, wherein the rod is a cylindrical rod.

9. The device of claim 1, wherein the base is configured to interface with an array of pipettes, and wherein each deposition tip in the array of deposition tips corresponds to a pipette in the array of pipettes.

10. The device of claim 1, wherein the device comprises a polymer from a group polypropylene, a cyclo-olefin (COC), polycarbonate (PC), polyether ether ketone (PEEK), and polytetrafluoroethylene (PTFE).

11. The device of claim 1, wherein the second end of the rod comprises a polymer ball

12. The device of claim 11, wherein a polymer of the polymer ball is a hydrophobic polymer.

13. The device of claim 11, wherein the polymer ball is about 500 microns to 700 microns in diameter.

14. The device of claim 11, wherein the polymer ball is a polymer from a group polydimethylsiloxane (PDMS), a silicone, and a hydrogel.

15. The device of claim 1, wherein the second end of each deposition tip of the array of deposition tips is about 9 millimeters from the second end of any other deposition tips in the array.

16. The device of claim 1, wherein the array of deposition tips is an 8×1 array of tips or an 8×12 array of deposition tips.

17. The device of claim 1, wherein each deposition tip of the array of deposition tips includes at least two liquid catches positioned on the rod, wherein a first liquid catch is positioned at the second end of the rod and a second liquid catch is positioned a distance from the first liquid catch, and wherein a liquid catch comprises a protrusion from the rod along a perimeter of the cylindrical cross-section of the rod.

18. A device comprising:
a base, the base having a first side and a second side; and
an array of deposition tips, the array of deposition tips being at least a 2×1 array of deposition tips, each deposition tip of the array of deposition tips comprising a rod having a first end and a second end; and
a spring proximate the first end of each deposition tip of the array of deposition tips, the spring operable to be compressed to enable motion of second end of each of the deposition tips substantially parallel to a length of each of the deposition tips.

19. A device comprising:
a base, the base having a first side and a second side, the second side comprising a planar surface; and
an array of deposition tips, the array of deposition tips being at least a 2×1 array of deposition tips, each deposition tip of the array of deposition tips comprising a rod having a first end a second end, at least two sections substantially perpendicular to the length of the rod extending at the first end of the rod, the at least two sections positioning the first end of the rod about 1 millimeter to 3 millimeters from the planar surface, and the two sections operable to be flattened against the base such that the first end of the rod is in contact with the base.

20. A method comprising:
injection molding a device, the device comprising a polymer, the device comprising:
a base, and
an array of deposition tips attached to the base, the array of deposition tips being at least a 2×1 array of deposition tips,
each deposition tip of the array of deposition tips comprising a rod having a cylindrical cross section, the rod having a first diameter at a first end and a second diameter at a second end, the first diameter being greater than the second diameter, the first end of the rod being attached to the base, and the rod including a bend comprising a cantilever spring.
